(19) United States
(12) Patent Application Publication
(10) Pub. No.: US 2011/0190105 A1
(43) Pub. Date: Aug. 4, 2011

(54) Fluid Encapsulation

(76) Inventor: Gary Fallon, London (GB)

(21) Appl. No.: 13/003,288

(22) PCT Filed: Jul. 3, 2009
(86) PCT No.: PCT/EP2009/058420

§ 371 Date: Apr. 7, 2011

(30) Foreign Application Priority Data
Jul. 11, 2008 (GB) 0812732.6

(51) Int. Cl. A24D 3/02; A24D 3/06; B31C 99/00

(52) U.S. Cl. 493/39; 264/4

(57) ABSTRACT

A fluid encapsulation (1) for use in the manufacture of smoking articles comprises first and second spaced, frangible fluid-containing members (4) and an elongate connecting member (2) coupling said fluid-containing members to one another.

### FIELD OF THE INVENTION

This invention relates to fluid encapsulation for use in the manufacture of smoking articles.

As used herein, the term “smoking article” includes smokeable products such as cigarettes, cigars and cigarillos whether based on tobacco, tobacco derivatives, expanded tobacco, reconstituted tobacco or tobacco substitutes and also heat-not-burn products. The smoking article may be provided with a filter for the gaseous flow drawn by the smoker.

### BACKGROUND TO THE INVENTION

It is known to provide a frangible capsule containing a flavourant such as menthol inside the filter of a smoking article. By applying pressure to the outside of the filter, the smoker may break the capsule therein and release the flavourant. Thus, a smoker wishing to add flavour to the inhaled gaseous flow may do so by simply squeezing the filter.

Individual breakable capsules having a flavourant therein and methods of manufacture thereof are known per se and are described in, for example, WO 2007/010407, WO 2006/136199 and WO 2006/136197 and EP0513603.

Hitherto, frangible capsules have been incorporated into the filter of a smoking article by dispensing individual capsules one by one from a delivery drum into a flow of tow during filter rod manufacture.

For a given desired machine speed, delivering the capsules one by one imposes a lower limit on the achievable separation between neighbouring capsules in the rod. The separation at which capsules are placed in the rod will also be referred to herein as the ‘pitch’. The pitch is limited by, for example, the speed at which the capsules can be fed into the machine and the number of capsules on the delivery drum.

The limitation to the pitch restricts the number of capsules which can be incorporated into a given length of filter rod. As a result, it would, for example, be difficult to incorporate more than one capsule into a length of filter suitable for use with a cigarette. Furthermore, it would be difficult to manufacture a multisection filter having a section which contains a capsule using the individual delivery method.

In addition, for a given desired pitch, the speed of operation of the filter rod is limited by the speed that the delivery drum can deliver the capsules into the tow.

Furthermore, additional machinery is required to synchronise the rotation of the delivery drum with the rest of the filter manufacturing process. This can limit the speed of operation of the filter making machine.

Furthermore, if there is a missed delivery due to blockages in the delivery system, this results in higher waste levels.

Moreover, the positioning or pitch of the capsules can be difficult to control, for example due to speed changes during machine start-up. This often requires sophisticated encoders in order to maintain a constant separation between the capsules.

Still further, as the capsule is delivered late in the filter rod manufacturing process, there is only one quality check to ensure it is in the rod, resulting in high waste levels.

### SUMMARY OF THE INVENTION

The present invention provides an alternative approach for providing one or more frangible capsules in smoking article filter rods.

The present invention provides a fluid encapsulation for use in the manufacture of smoking articles, comprising first and second, spaced frangible fluid-containing members and an elongate connecting member coupling said frangible fluid-containing members to one another.

As is described in more detail hereinbelow, the fluid encapsulation can be used in a cigarette filter making machine to incorporate the fluid containing members into a filter rod.

The pitch at which the capsules can be placed in the rod is determined by the separation between the fluid containing members of the fluid encapsulation. Thus a low separation between capsules in the rod can be achieved. As described in more detail hereinbelow, it is therefore possible to use the fluid encapsulation to manufacture multi-section filters having a section with a frangible fluid containing member inside.

Furthermore, as will be described in more detail herein below, use of a fluid encapsulation in a filter manufacturing machine to incorporate capsules into a filter rod has fewer moving parts and can be operated at a faster speed than a cigarette filter making machine in which the capsules are individually dispensed into the rod.

Furthermore, the positioning of the fluid containing members is determined by the position of the fluid containing members within the fluid encapsulation. Therefore, the positioning/pitch of the capsules is maintained, even if the speed of the machine fluctuates during start up.

According to the invention, there is also provided a method of making a filter rod for use in smoking article manufacture, the method comprising feeding a fluid encapsulation such that at least one frangible, fluid-containing member is disposed within the rod.

Feeding the fluid encapsulation may comprise pushing the fluid encapsulation, or pulling the fluid encapsulation.

The fluid encapsulation may be drawn from the holder into a moving, continuous fibrous mass.

The method of making a filter rod may further comprise wrapping the continuous fibrous mass having the fluid encapsulation therein with a paper wrapper and cutting the wrapped fibrous mass having the fluid encapsulation therein so as to form the filter rod.

Part of the paper wrapper may be in frictional contact with a belt such that movement of the belt imparts movement to the paper wrapper. Furthermore, part of the continuous fibrous mass may be in frictional contact with the paper wrapper such that movement of the paper wrapper imparts movement to the continuous fibrous mass, thereby moving said continuous fibrous mass. Furthermore, part of the fluid encapsulation may be in frictional contact with the continuous fibrous mass such that movement of the continuous fibrous mass imparts movement to the fluid encapsulation, thereby drawing the fluid encapsulation from the holder and into the continuous fibrous mass.

The invention also provides a method of making a multi-section filter for a smoking article, comprising making a first filter section, aligning the first filter section with a second filter section and wrapping the first filter section and the second filter section with a paper wrapper so as to join them together, thereby forming the multi-section filter.

The first filter section may be the whole or a cut part of a filter rod made using a fluid encapsulation. The first filter section may comprise a gelatin capsule having a flavourant therein and the second filter section may comprise charcoal.

The invention also provides a method comprising forming an elongate connecting member between first and second frangible, fluid-containing members, thereby making a fluid encapsulation for use in the manufacture of smoking articles, the fluid encapsulation comprising the first and second frangible, fluid-containing members and the elongate connecting member.

The invention also provides an apparatus for making a filter rod for a smoking article, the apparatus comprising a feeding mechanism configured to feed a fluid encapsulation such that such that at least one frangible, fluid-containing member is disposed within the rod.

The invention also provides an apparatus comprising an assembly station configured to form an elongate connecting member between first and second frangible, fluid containing members, thereby making a fluid encapsulation for use in the manufacture of smoking articles, the fluid encapsulation comprising the first and second, frangible, fluid-containing members and the elongate connecting member.

The invention also provides a filter for a smoking article, the filter comprising a fluid encapsulation, the fluid encapsulation having a frangible fluid-containing member and a part of an elongate connecting member coupled to the frangible fluid-containing member.

The filter may have first and second sections, and the fluid encapsulation may be contained in the first section.

The filter may comprise a second fluid encapsulation, and the second fluid encapsulation may comprise a frangible fluid-containing member and a part of an elongate connecting member coupled to the frangible fluid-containing member, and the second fluid encapsulation may be contained in the second filter section.

The invention also provides a smoking article comprising a filter as described herein.

### BRIEF DESCRIPTION OF THE DRAWINGS

In order that the invention may be more fully understood, embodiments thereof will now be described by way of illustrative example with reference to the accompanying drawings, in which:

FIG. 1 illustrates cross sections of parts of a fluid encapsulation.

FIG. 2 illustrates a machine for making filter rods using a fluid encapsulation.

FIG. 3 illustrates part of a machine for making filter rods using a fluid encapsulation.

FIG. 4 illustrates part of a machine for making filter rods using a fluid encapsulation.

FIG. 5 illustrates a filter rod manufactured by the machine illustrated in FIG. 1.

FIG. 6 illustrates a cigarette assembly process.

FIG. 7 shows an assembled cigarette.

FIG. 8 shows another filter rod having a cut part of a fluid encapsulation therein.

FIG. 9 illustrates a process of assembling multi-section filter rods.

FIG. 10 illustrates a cigarette assembly process using a multi-section filter rod.

FIG. 11 shows a machine for making a fluid encapsulation.

FIG. 12 shows a part of a machine for making a fluid encapsulation.

FIG. 13 shows a part of a machine for making a fluid encapsulation, the fluid encapsulation having two different types of flavourant therein.

FIG. 14 shows a fluid encapsulation containing capsules having different flavourants therein, a filter rod manufactured using the fluid encapsulation and a cigarette manufactured using the filter rod.

FIG. 15 shows another machine for making a fluid encapsulation.

### DETAILED DESCRIPTION

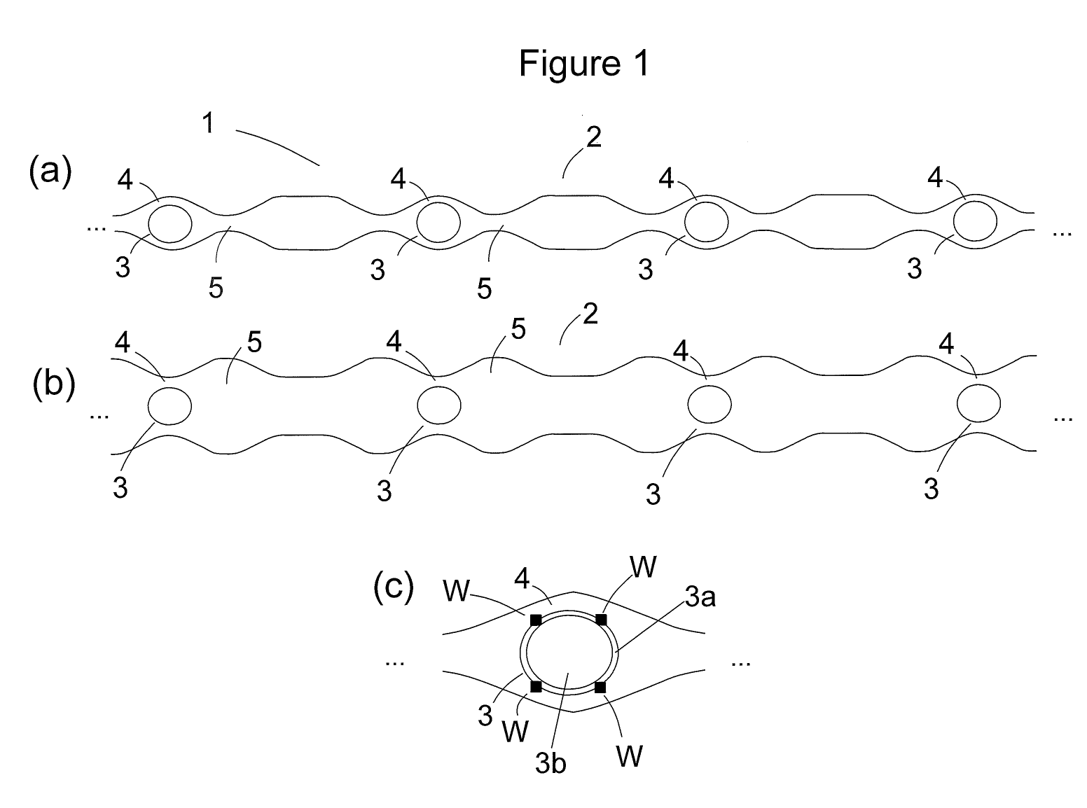

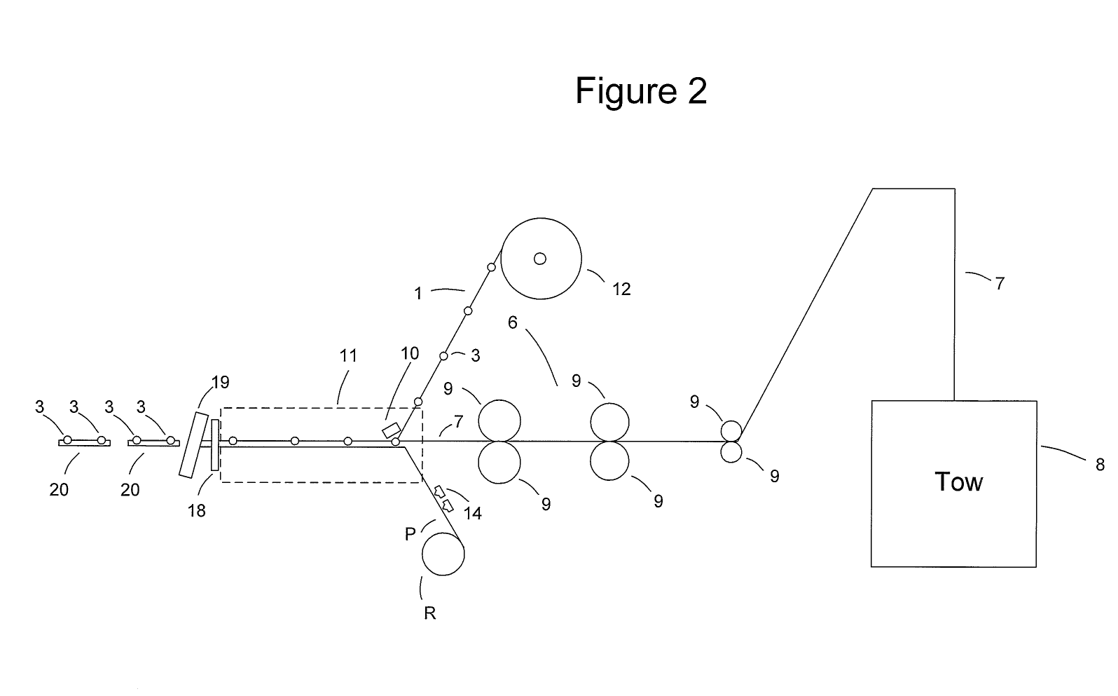

FIGS. 1(a) and 1(b) show orthogonal sectional views of one example of a fluid encapsulation 1. As shown, the fluid encapsulation 1 comprises an elongate connecting member 2 containing a plurality of fluid-containing capsules 3 in pocket regions 4. As illustrated in FIG. 2(c), each capsule 3 may comprise an outer wall 3a of gelatin and an inner space 3b filled with a liquid flavourant. Each capsule is optionally fixed to the interior of one of the pocket regions 4 by ultrasonic spot welds W to securely locate the capsules along the connecting member 2.

As shown in FIGS. 1(a) and 1(b), the elongate connecting member 2 is in the form of a tube having the pocket regions 4 evenly spaced therealong. Spot welding of the capsules to the interior of the tube has caused the tube to become flattened in regions 5 on either side of each capsule, to define its corresponding pocket region 4.

The connecting member 2 may be made from porous plugwrap, which is permeable to the gaseous flow drawn through a cigarette by a smoker. Porous plugwrap is typically used in the art as a wrapper for cigarette filters. The connecting member 2 may, alternatively or in addition, comprise acetate. Alternatively, or in addition, the connecting member 2 may comprise cellulose or wood pulp fiber papers or impregnated paper having an additive such as carbon.

As is described in more detail hereinbelow, the fluid encapsulation 1 can be used during cigarette manufacture to incorporate the gelatin capsules 3 into the filter of a cigarette. The gelatin capsules 3 contain a flavourant, such as, for example, menthol, which can be released by the smoker of the cigarette into the filter tow by squeezing the outside of the filter to rupture the outer wall 3a of the capsule.

FIG. 2 shows a machine 6 for manufacturing filter rods having gelatin capsules disposed therein. The machine 6 uses a fluid encapsulation 1, such as that shown in FIG. 1 and described hereinabove, to incorporate the capsules into the rods.

In the machine 6, filter tow 7 is drawn from a source of tow 8 through a set of conveying rollers 9, and is compressed through a nozzle (not shown) and through the tongue 10 of garniture 11. The fluid encapsulation 1 is drawn from a reel 12 and fed through the tongue 10 so as to incorporate the encapsulation into the flow of tow 7.

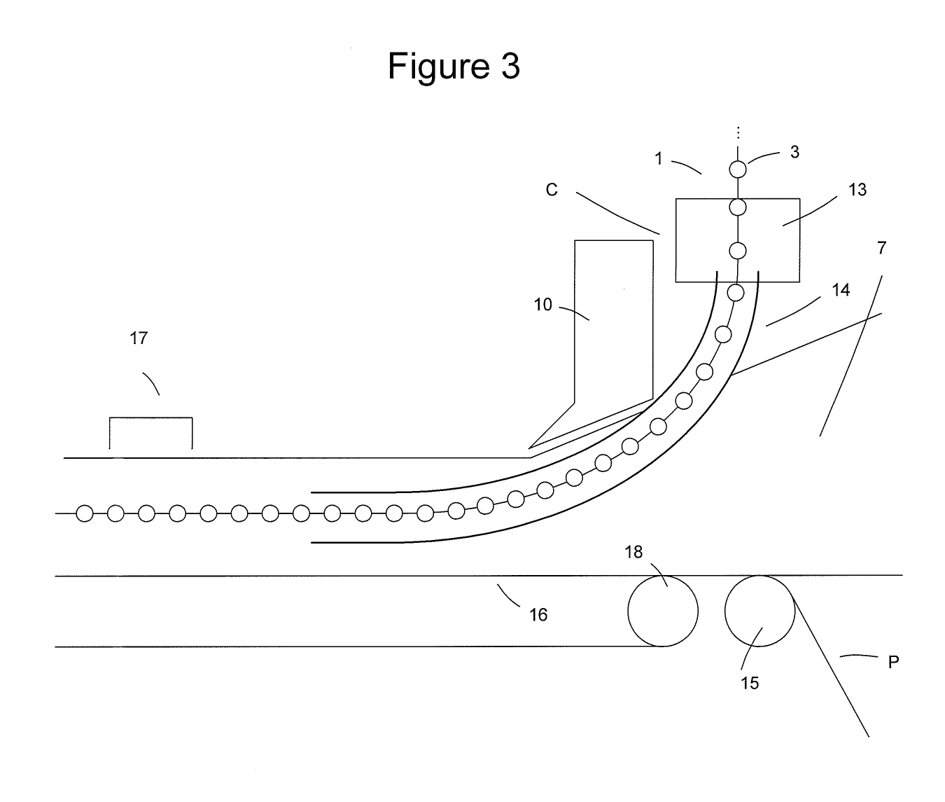

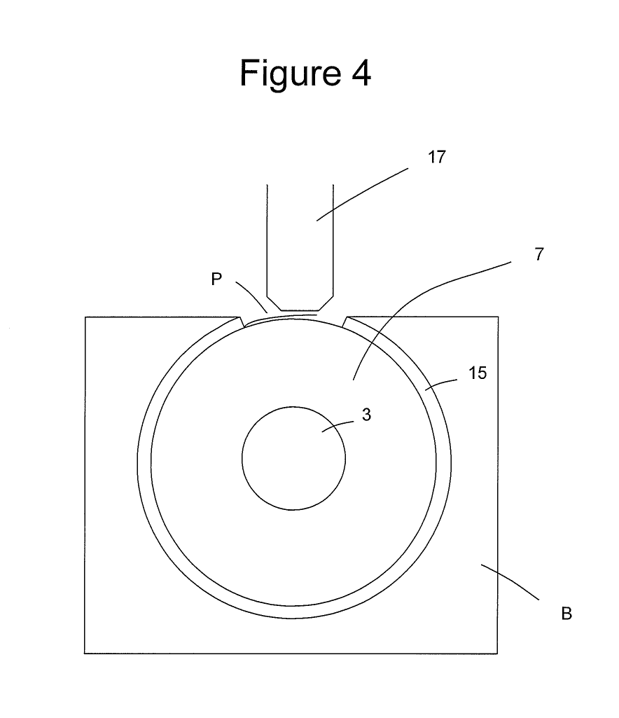

FIGS. 3 and 4 show orthogonal sectional views of garniture region 11. As shown, the fluid encapsulation 1 is fed through the tongue 10 via a centering device C in order to axially center the fluid encapsulation in the flow of tow. The centering device C has an adjustment block 13 which is connected to a hollow tube 14 which guides the fluid encapsulation into the centre of the flow of tow 7. The adjustment block is offset from the fluid encapsulation in a direction into the page of the drawing. The adjustment block is configured to adjust the position of the hollow tube such that the fluid encapsulation is centrally disposed inside the eventual rod.

In the garniture, the tow and the fluid encapsulation therein are wrapped in a plug wrap P drawn from a reel R via a roller 15, so as to form an elongate filter rod. An endless garniture tape 16 travels along the garniture bed B, guided by roller 18, and drags the plug wrap, the tow, and the fluid encapsulation through the garniture. The garniture tape 16 curves inwardly as it travels through the garniture, thereby shaping the plug wrap such that the tow and fluid encapsulation therein are cylindrically paper wrapped. The glue guns 14 apply an adhesive such as hot melt glue or polyvinyl acetate (PVA) to the plug wrap. A sealing unit 17, which has a heating or a cooling element, seals the plugwrap around the filter tow. PVA or glue may also be used to lay down an anchorage line on the plug wrap prior to combining it with the tow so that the tow and plug wrap stick together in the garniture.

Referring to FIG. 2, the machine 6 includes a microwave detector 18 for detecting the presence or location of capsules 3, and a cutter with a knife 19 for cutting the elongated filter rod and the connecting member of the fluid encapsulation therein, thereby forming filter rod segments 20. The connecting member is cut at a point between the capsules 3.

On start up, a capsule position is determined by the microwave detector 18 and the cut-off position of the cutter knife 19 is adjusted to position the capsule in the correct position relative to the knife. Furthermore, the detected capsule position may be used to determine the time that the cutter should begin cutting.

The microwave detector 18 also acts as a quality detection device. The microwave 18 detector detects defects in the fluid encapsulation 1, such as damaged or missing capsules in the rod. The machine has a shift register (not shown) which is configured to discard a detected defective element at a later stage in the assembly process. For example, if the microwave detector determines that a capsule is defective, the shift register may be configured such that the assembled filter rod containing that capsule is discarded.

The fluid encapsulation 1 may comprise a plurality of smaller lengths of fluid encapsulation spliced together by a supplier. Along the reel 12 there is a detection system (not shown) configured to detect splices in the fluid encapsulation. This is an optical device which detects colour variation, and which is linked to the machine's inspection system and shift register. The machine is programmed to use the shift register to eject damaged product after the cut off knife 19 through the machine's ejection systems (not shown).

Furthermore, although the fluid encapsulation 1 has been hereinabove described as having one capsule 3 in each pocket region 4, alternatively the fluid encapsulation may have two or more capsules in each pocket region.

Conventional filter rods, which do not contain gelatin capsules, are manufactured by conventional filter manufacturing machines which are well known per se and will not be described herein. An advantage of the present invention is that it may be implemented in such a conventional filter manufacturing machine.

As described above, the fluid encapsulation 1 is pulled through the machine 6 by the garniture tape together with the plugwrap and the tow. Thus, the speed at which the encapsulation is fed into the machine is automatically synchronised with the garniture speed. In contrast, individual delivery systems require a separate delivery system and additional machinery to synchronise the rotation of the delivery drum with the speed of the garniture. These additional moving parts can impose limitations on the speed of operation, and are not required by the filter making machine 6. In addition, the machine 6 can be more easily configured to operate at the highest speeds, since the speed at which the encapsulation is fed into the machine is limited by the garniture speed only.

The pitch of the capsules in the filter rods manufactured by machine 6 is the same as, and defined by, the separation between the capsules of the fluid encapsulation. This separation may, for example, be in the range 7-30 mm, although longer or shorter separations are also possible.

Thus, in the filter rods manufactured by the machine 6, the pitch is independent of the speed at which the capsules are fed into the machine. In contrast, in individual delivery systems, the pitch is limited by the speed at which the capsules can be fed into the machine and the number of capsules on the delivery drum. Thus, a shorter separation between the capsules in the rod can be achieved by the machine 6 as compared with other filter manufacturing machines.

Furthermore, in the machine 6, the capsules are pre-positioned in the encapsulation prior to being fed into the machine, resulting in reduced waste on the machine due to capsule positioning errors and hence reduced total waste. The process is therefore more efficient than the prior process in which the capsules are delivered individually and will waste less tow. Thus, the machine 6 results in lower waste levels than a filter making machine in which loose capsules are individually dispensed.

Furthermore, in individual delivery systems if a capsule is not correctly picked up by the delivery drum, the machine will manufacture a defective filter rod with a missing capsule. In contrast, it is possible to check that the fluid encapsulation 1 contains a capsule in every pocket region 4 prior to loading the encapsulation 1 onto the reel 12, thereby ensuring single capsule feeding.

Still further, the positioning of the capsules within the filter rod is determined by the position of the capsules within the fluid encapsulation. Therefore, the positioning/pitch of the capsules can be maintained, even if the speed of the machine fluctuates, for example during start-up, or if the tow carrier moves due to tow stretching, compression or relaxation as it passes through the machine.

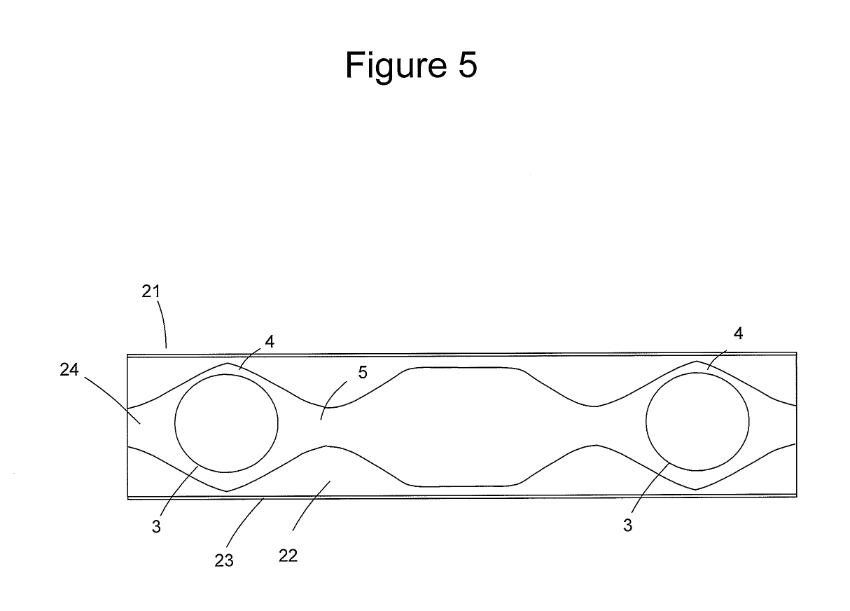

FIG. 5 shows a filter rod 21 manufactured by the machine 6. The filter rod comprises a plug of cellulose acetate tow 22 wrapped with a wrapper of porous plugwrap 23. A cut section 24 of the connecting member 2, which contains two fluid-containing capsules 3, is disposed inside the rod. The diameter of the filter is within the range 4-10 mm. The capsule diameter is within the range 2-6 mm. As described hereinbelow, the filter rod 21 is used in the manufacture of a pair of cigarettes. The separation between the capsules in the filter rod 21 is chosen to be in the range 11-32 mm so that a single capsule is disposed in the filter of each cigarette.

These ranges are not, however, intended to be limiting and the skilled person would understand that larger or smaller filter diameters, capsule diameters or capsule separations could be employed.

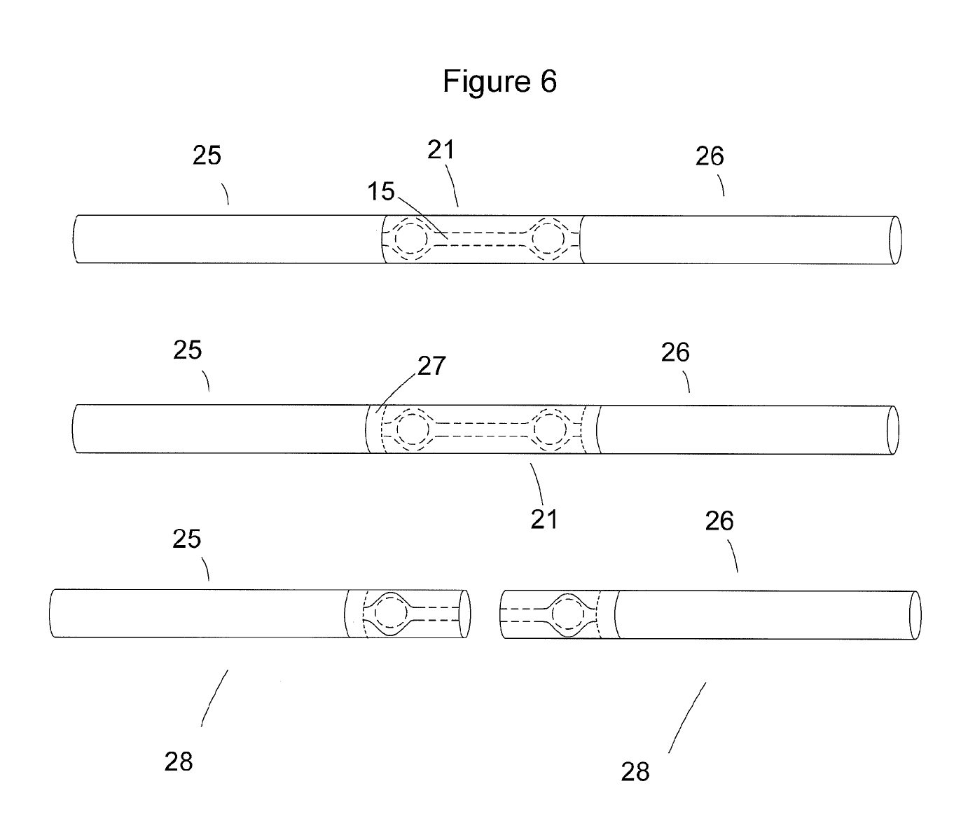

The filter rod 21 shown in FIG. 5 can be used in the assembly of cigarettes. Referring to FIG. 6, a cigarette is assembled by axially aligning filter rod 21, a first paper wrapped tobacco rod 25, a second paper wrapped tobacco rod 26 and wrapping them with a glue coated segment of tipping paper 27 to join them together. The wrapped filter rod is then cut, thereby forming a pair of assembled cigarettes 28. Assembling stations for assembling cigarettes in this manner are well known per se and will not be described in detail herein.

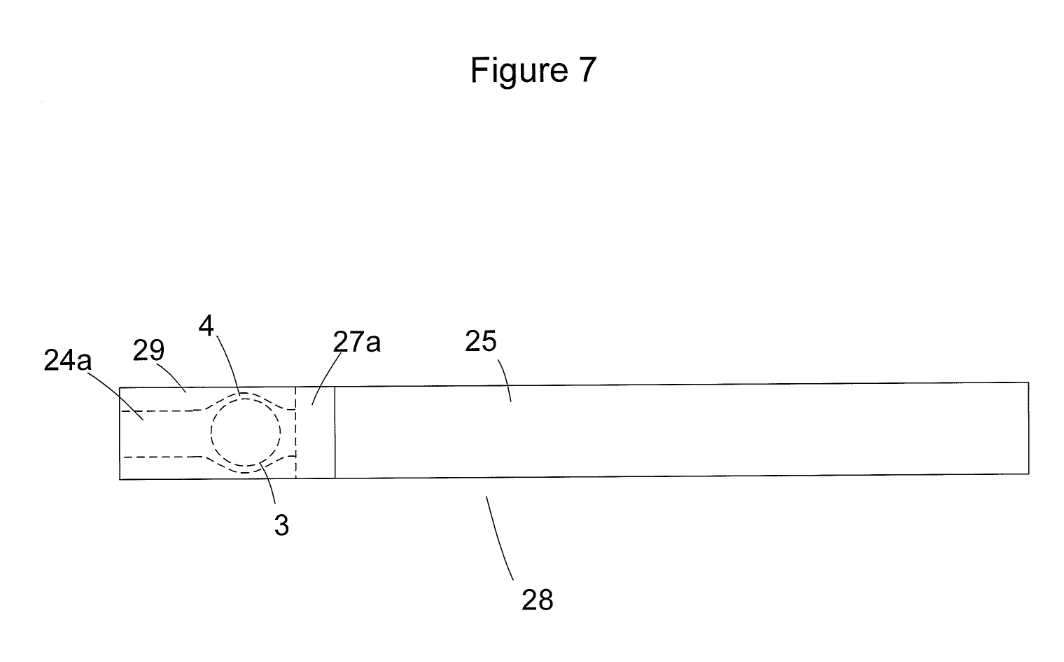

FIG. 7 shows a cross section of an assembled cigarette 28. The assembled cigarette 28 comprises a filter 29, a rod of generally cylindrically paper wrapped tobacco 25 and a generally cylindrically wrapped segment of tipping paper 27a. A cut section of the connecting member 24a, which contains a pocket region 4 containing a gelatin capsule 3, is disposed inside the filter 29. A smoker may rupture the capsule by squeezing the filter and thereby release the flavourant. When the cigarette is smoked, part of the gaseous flow drawn by the smoker permeates the porous plugwrap surface of the pocket region and is flavoured as it passes through the flavourant.

Use of the fluid encapsulation 1 to incorporate gelatin capsules 3 into the filter of a cigarette allows the position of the capsules to be precisely controlled. For example, the centering device C of the machine 6 allows the capsules to be accurately centred axially within the filter. This is an advantage since off-centre capsules may be palpable to the user, who may consequently perceive a cigarette as defective. Furthermore, off-centre capsules may burst prematurely during cigarette manufacture, transport or storage.

Still further, the machine 6 allows the capsules to be placed in the same position within each filter. Thus, the smoker's experience is uniform from cigarette to cigarette.

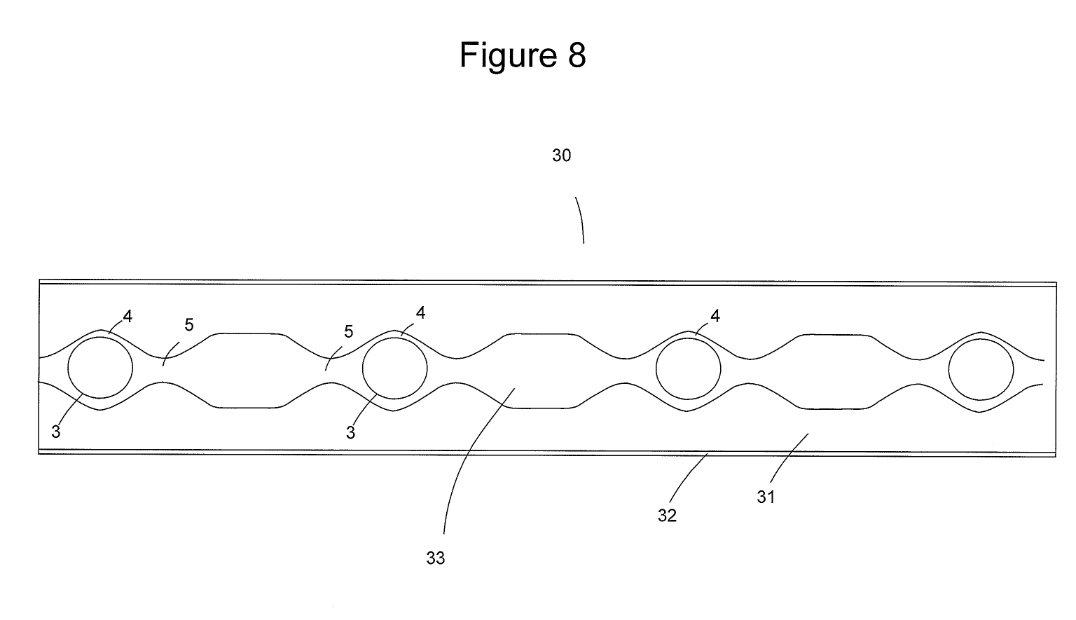

FIG. 8 shows another type of filter rod 30 which can be manufactured by the machine 6. The filter rod comprises a plug of cellulose acetate tow 31 wrapped with a wrapper of porous plugwrap 32. A cut section 33 of the connecting member 2, which contains four fluid-containing capsules 3 is disposed inside the rod. Each fluid-containing member 3 has a menthol flavourant therein. As described below, the filter rod 30 may be used in the manufacture of a multi-section filter. For a triple segment filter, the separation between the capsules in the filter rod 30 can be chosen to be in the range 7-10 mm so that a single capsule is disposed in the filter of each cigarette.

The filter rod 30 can be used in the manufacture of a multi-section filter rod. Machines for manufacturing multi-section filters from different filter sections are known, per se and will not be described in detail herein. For example, the MERLIN machine, manufactured by Hauni Maschinenbau, receives up to four different types of filter and combines them together to form multi-section filters.

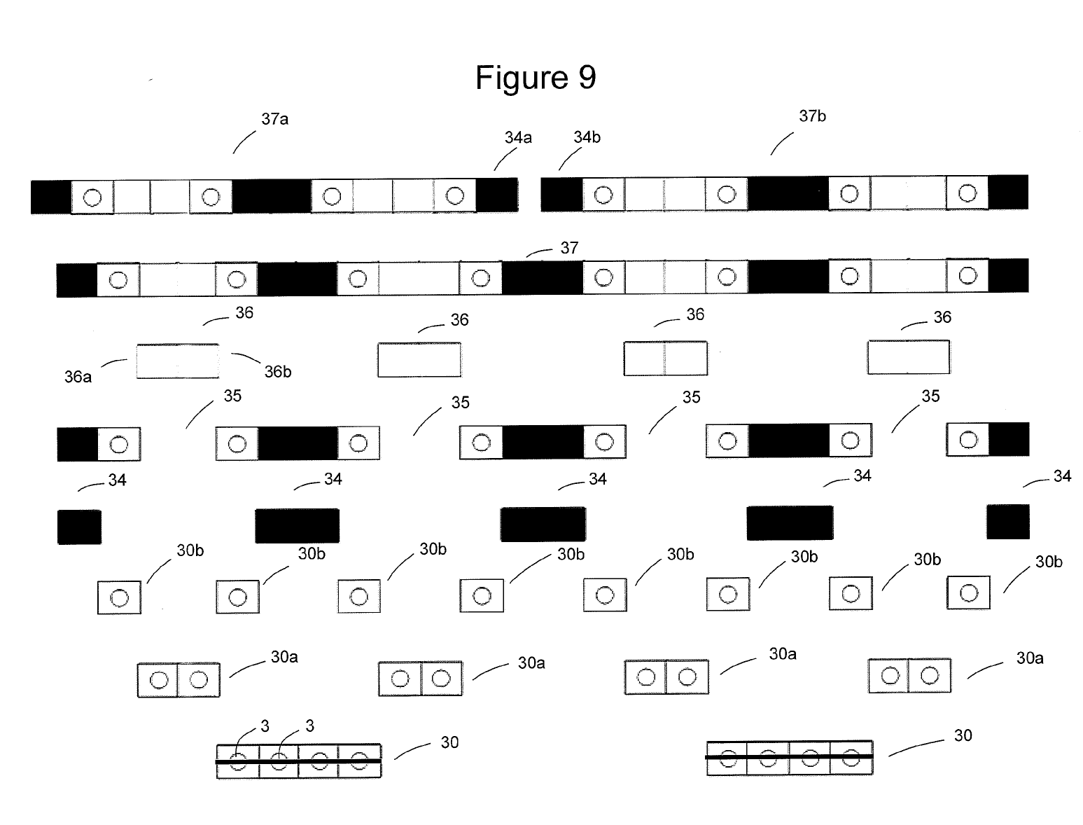

In one example, the filter rod 30 is used to manufacture a multi-section filter having a charcoal section and a section containing a capsule. A process of assembling such a filter rod is illustrated in FIG. 9, which shows filter sections at various stages of assembly.

Referring to FIG. 9, a plurality of filter rods 30 are each cut in half to form a plurality of cut filter rods 30a, each having two menthol-containing capsules therein. These cut filter rods are subsequently cut again to form filter rods having a cut section of the connecting member 30b having a gelatin capsule therein.

As shown, the cut filter rods are then combined with charcoal-containing filter sections 34. Two cut filter rods 30b are arranged on opposing sides of each charcoal-containing section 34. A gap 35 is arranged between each combined filter section. A further filter section 36 comprising two mouthpiece sections 36a, 36b is then arranged in the gap, thereby forming a length of combined filter sections 37. Each mouthpiece section preferably comprises cellulose acetate tow.

Every second charcoal-containing filter section is then cut, thereby forming charcoal-containing sections 34a and 34b and separating the length of combined filter sections into parts 37a and 37b.

Each part 37a, 37b therefore comprises first and second charcoal-containing sections 34a, 34b, a charcoal containing section 34, first, second, third and fourth capsule-containing sections 30b and first and second mouthpiece sections 36, each containing mouthpiece sections 36a 36b. Each part 37a is then wrapped with a glue coated paper section in order to join the filter sections together, thereby forming a multisection filter rod.

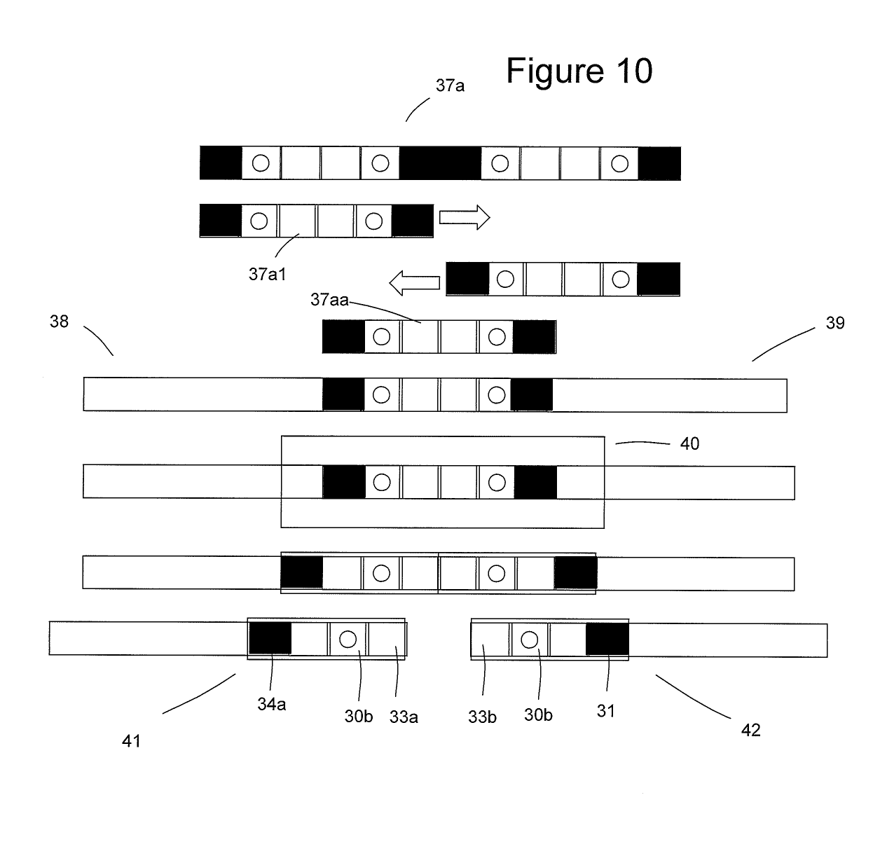

FIG. 10 illustrates a cigarette assembly process using a multisection filter rod 37a. As shown, the multisection filter rod 37a is cut into two parts, each one of which is used to make two cigarettes. A pair of cigarettes are assembled from each part by axially aligning a segment 37a1, a first paper wrapped tobacco rod 38, a second paper wrapped tobacco rod 39 and wrapping them with a glue coated segment of tipping paper 40 to join them together. The wrapped filter rod is then cut, thereby forming a pair of assembled charcoal-menthol cigarettes 41, 42.

The filter of the assembled charcoal-menthol cigarette 41, 42 comprises a charcoal segment 34, a segment containing a capsule 30b and a mouthpiece 36a, 36b. The capsule 3 is contained inside a cut section 33 of the connecting member 2 and the connecting member 2 is contained inside the segment 30b.

The capsule 3 provides a boundary between the menthol flavourant inside the capsule and the charcoal flavourant so that the menthol is not absorbed by the charcoal. The smoker can obtain a menthol flavour by squeezing the filter and breaking the capsule, while the charcoal provided in the filter reduces the concentration of certain gases in the gaseous flow inhaled by the smoker.

It is noted that charcoal-menthol cigarettes would be very difficult to manufacture by other filter manufacturing techniques. For example, if the menthol is not encapsulated, it may be absorbed by the charcoal prior to smoking the cigarette. However, providing the menthol in a capsule contained in a section of a multi-section filter requires a pitch which is difficult to achieve by the individual delivery method. Thus, the present invention has the advantage that charcoal-menthol filters and cigarettes can be more easily manufactured as compared with techniques in which the menthol is not encapsulated or in which the capsules are delivered individually.

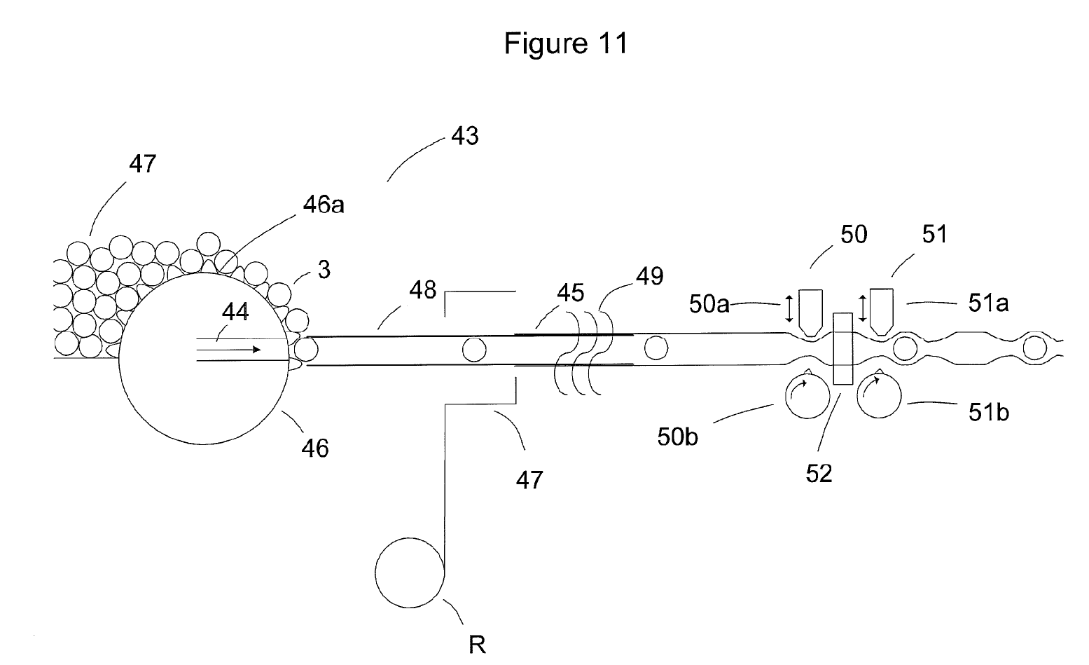

FIG. 11 shows a machine 43 for making a fluid encapsulation such as the fluid encapsulation 1 shown in FIG. 1 and described hereinabove. As shown in FIG. 11, capsules 3 are blown by an air-jet 44 from a capsule dispenser into a paper tube 45, where they are secured in place within the tube by ultrasonic spot welding.

The machine comprises a capsule dispenser in the form of a rotatable hopper 46 having pockets 46a for holding the capsules 3, each pocket having an airhole therein.

As the hopper rotates, individual capsules 3 from capsule supply area S are received by the pockets 46a and are guided into the path of a compressed air jet 44, which blows the capsules sequentially down a cylindrical metal tube 48 and into paper tube 45.

The paper tube 45 is formed from a paper sheet such as a ribbon of porous plugwrap, which is fed from a reel R, around forming block 47 and over the metal tube 48. The paper tube may, alternatively or in addition, comprise acetate. Alternatively, or in addition, the paper tube may comprise cellulose, wood pulp fiber papers or impregnated paper having a secondary material such as carbon. The tube may be formed such that one edge of the paper overlaps with the other. Referring to FIG. 11, as the formed material passes over the metal tube, it runs under an ultrasonic welding device (not shown) which welds the overlapping edges longitudinally together with ultrasound 49, thereby forming the tube.

The hopper 46 has a sensor (not shown) for detecting the presence of the capsule in the pocket. If the sensor determines that there is no capsule in the pocket, the machine will temporarily accelerate the rotation of the hopper 46 so that the next filled pocket 46a is brought into the path of the compressed air stream at the time of the next compressed air pulse.

The machine 43 has a further detector which identifies if there is a trapped capsule in the pocket prior to the rotary hopper collecting another capsule.

The machine further comprises first and second rotary ultrasonic welders 50, 51 for spot welding each capsule to the paper tube. Spot welds are used in order to allow good air flow in the eventual filter, thus maximizing the proportion of the gaseous flow drawn by the smoker which permeates the porous plugwrap and flows through the flavourant.

As shown, each ultrasonic welder 50, 51 comprises a rotary anvil 50a, 51a and an oscillating ultrasonic head 50b, 51b. The oscillation of the ultrasonic head 50a and the rotation of the rotary anvil 50b of the first ultrasonic welder 50 are timed such that the front part of each capsule blown from the hopper 46 is welded to the tube by the ultrasonic welder 50. The oscillating head then lifts and the rotary anvil rotates, thereby allowing the capsule to be carried by the paper to which it is attached past a detector 52, which detects whether a capsule is present, and past the second ultrasonic welder 51. The oscillation of the ultrasonic head 51a and the rotation of the rotary anvil 51b of the second ultrasonic welder 51 are timed such that the back part of each capsule is welded to the tube.

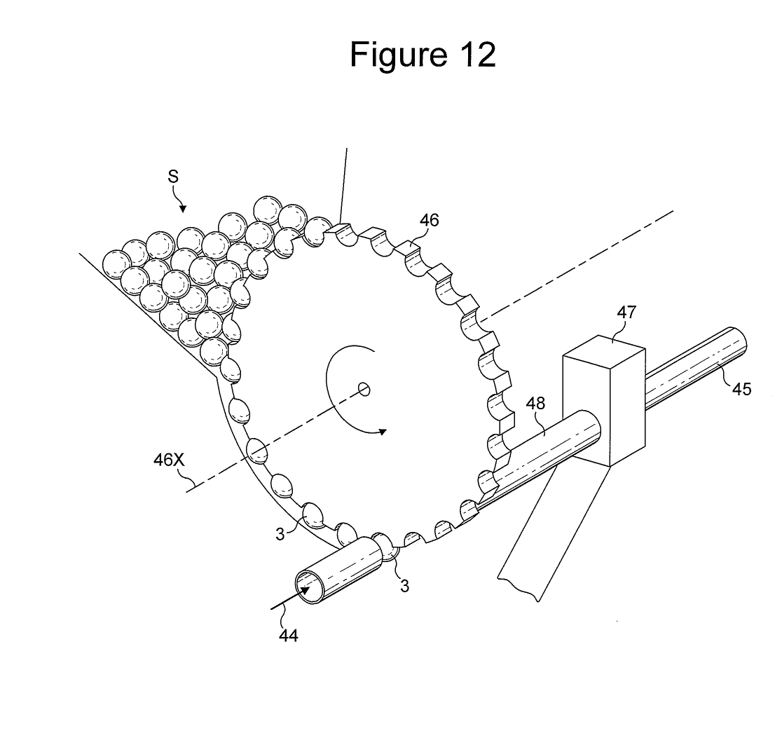

FIG. 12 illustrates an alternative arrangement of rotatable hopper 46. As shown, the axis of rotation 46X of the hopper 46 is parallel to the direction of compressed air stream 44. That is, the hopper 46 moves perpendicularly to the direction of the air stream 44. As shown, capsules 3 fall into the pockets of the rotatable hopper and are guided into the path of a compressed air pulse 44 so as to be blown down metal tube 48 and into paper tube 45, formed by forming block 47.

Alternatively the axis of rotation of the hopper 46 may make an angle relative to the direction of the compressed air such that the capsules have a velocity component along the direction of the compressed air prior to being blown into the tube. Such a configuration also has the advantage of increasing the surface area of region in which the capsules enter the hopper. In one example, the axis of rotation of the hopper makes an angle of 45° with respect to the direction of the compressed air flow.

The fluid encapsulation 1 may be formed from a plurality of lengths which are joined together by splices. For example, if during a first manufacturing run, a first length of fluid encapsulation is formed and during a subsequent manufacturing run, a second length of fluid encapsulation is formed, the first and second lengths may be spliced together to form a combined fluid encapsulation. In order to splice lengths of fluid encapsulation to one another, the machine 43 includes an additional ultrasonic welding station (not shown), located on the machine. A visual marking for the filter machine to recognise the splice and eject the corresponding material may be provided on the spliced fluid encapsulation

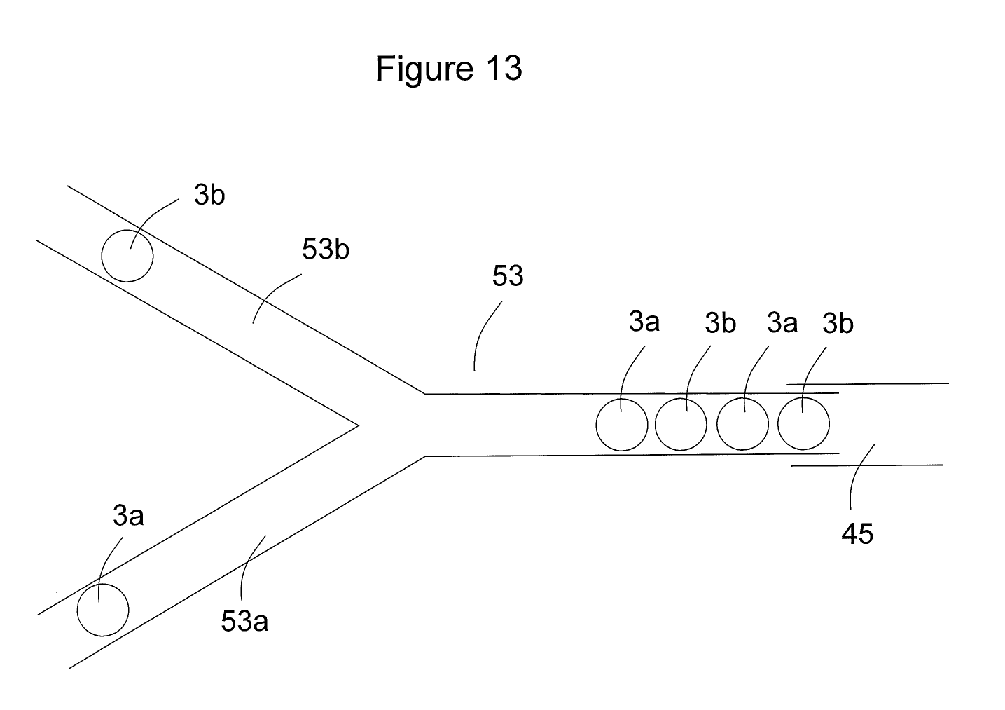

A fluid encapsulation may be formed so as to have more than one type of flavourant. For example, the fluid encapsulation may be formed so that adjacent fluid containing members therein contain first and second different flavourants. A machine for making such a fluid encapsulation may have a first hopper for supplying first capsules containing a first flavourant into the machine and a second hopper for supplying second capsules containing a second, different, flavourant into the machine. In this case, instead of blowing the capsules into a straight metal tube, the capsules may be blown into the branches of a branched guiding member 53 and thereby combined in the same paper tube 45. Referring to FIG. 13, the first and second capsules (3a, 3b) are respectively delivered down first and second branches (53a, 53b) of Y shaped guiding member 53 by blowing the capsules (3a, 3b) from the first and second hoppers (not shown) with first and second compressed air pulse trains (not shown), thereby combining the first and second capsules in the same paper tube 45. The first and second compressed air pulses trains are respectively synchronised with the rotation of the first and second hoppers. The delivery times of the first and second capsules from the first and second hoppers may be determined so that first and second capsules are alternately delivered into the paper tube. The capsules are subsequently spot welded to the tube, as described hereinabove, thereby forming a fluid encapsulation 54.

It will be apparent to the skilled person that a fluid encapsulation may be manufactured so as to have more than two encapsulated flavourants therein. A machine for manufacturing such a fluid encapsulation could have more than two hoppers and the branched member for combining the capsules into the same paper tube could have more than two branches.

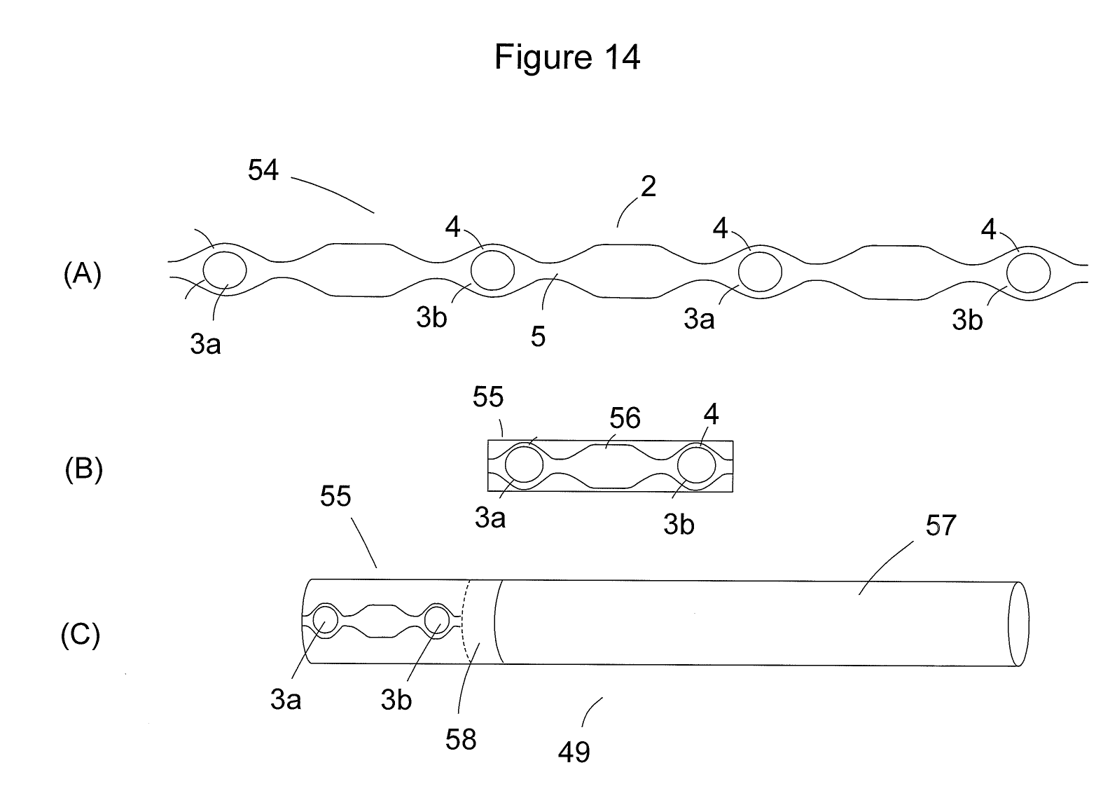

FIG. 14(a) shows fluid encapsulation 54, in which adjacent capsules 3a, 3b therein contain first and second different flavourants. The fluid encapsulation 54 may be used to incorporate the first and second capsules 3a, 3b into a filter rod by, for example, loading the fluid encapsulation 54 onto the reel 12 of the machine 6 described hereinabove, and feeding the encapsulation into contact with a flow of tow, as described hereinabove with reference to FIG. 2.

FIG. 14(b) shows a filter rod 55 containing a part of the fluid encapsulation 54. As shown, the filter rod comprises a cut section 56 of the paper tube 45, which contains a capsule 3a having a first flavourant, and a capsule 3b having a second flavourant. The separation between the capsules in the filter rod 55 is in the range 7-10 mm.

The filter rod 55 shown in FIG. 14(b) can be used in the assembly of a cigarette having two capsules in the filter, each capsules containing a different flavourant. Such a cigarette 56 is shown in FIG. 14(c). The cigarette 56 is assembled by axially aligning the filter rod 55 and a paper wrapped tobacco rod 57, and wrapping them with a glue coated segment of tipping paper 58 to join them together. Assembling stations for assembling cigarettes in this manner are well known per se and will not be described in detail herein.

By applying pressure to the outside of the part of the filter 55 which surrounds the capsule 3a, the smoker may break the capsule 3a and release the first flavourant therein. Alternatively, or in addition, by applying pressure to the outside of the part of the filter 55 which surrounds the capsule 3b, the smoker may break the capsule 3b and release the second flavourant therein. Thus, a smoker may add the flavour of the first flavourant, the flavour of the second flavourant or the flavour of the first and second flavourants mixed together to the inhaled gaseous flow by rupturing one or the other, or both capsules.

Although the fluid encapsulation has been described in terms of gelatin capsules contained in pocket regions of a porous plugwrap connecting member, many other variations will be evident to those skilled in the art.

For example, a fluid encapsulation may be manufactured by a modified co-extrusion process.

As described in WO 2007/010407, WO 2006/136199 and WO 2006/136197 and EP0513603, individual breakable capsules having a flavourant therein can be manufactured by a co-extrusion process. In the co-extrusion process, two fluids having different solubility may be extruded so that a capsule is created by surface tension.

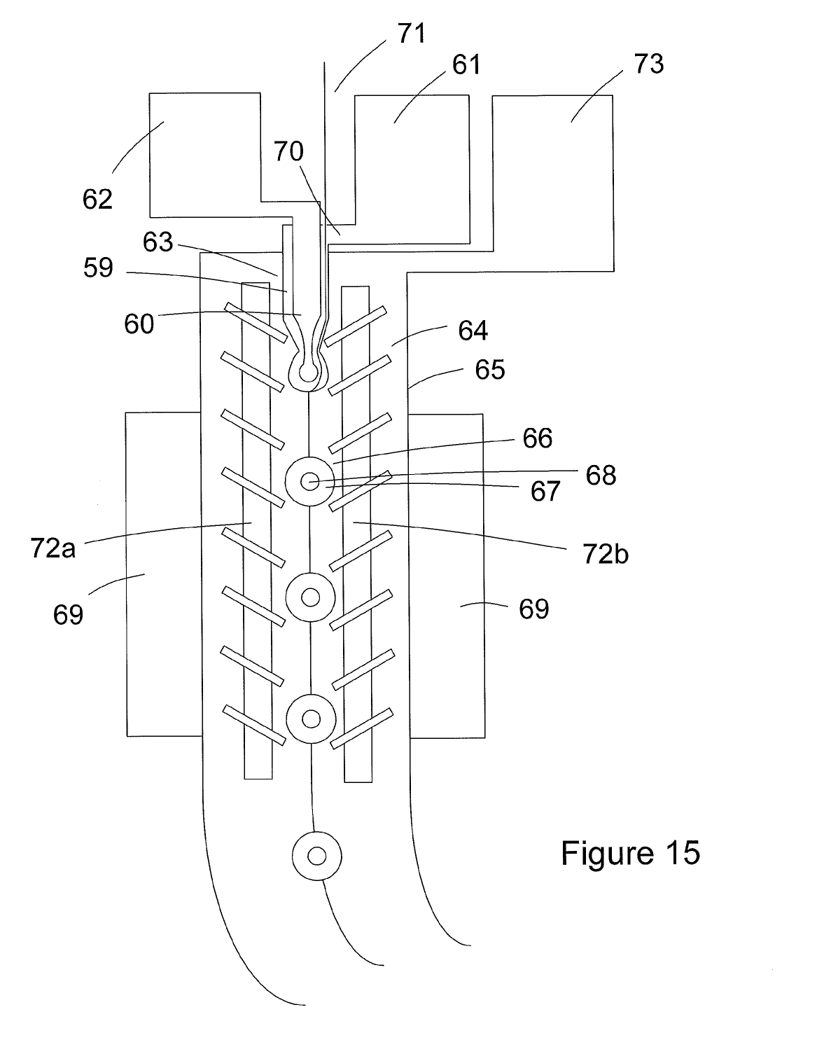

FIG. 15 illustrates an apparatus for manufacturing a fluid encapsulation by a modified co-extrustion process, the fluid encapsulation having first and second frangible fluid containing members coupled together by an elongate connecting member.

As shown, shell fluid 59, in the form of a warm gelatin solution, and liquid flavourant 60, in the form of menthol, are respectively delivered under pressure from tanks 61 and 62 into two-fluid nozzle 63. The shell fluid and liquid flavourant flow from the nozzle into a pipe 65 of carrier fluid 64, where they form droplets 66 having an outer shell of gelatin 67 and an inner core of menthol 68. Carrier fluid 64 may, for, example be vegetable oil, or may, for example, be another liquid in which gelatin is not soluble. A cooling mechanism 69 is provided on the outside of the pipe to cool and solidify the gelatin shell fluid. The fluid encapsulation thus formed may be subsequently removed from the pipe and dried to remove excess carrier material 64.

The shell liquid may be delivered to the nozzle 63 by a shell liquid delivery unit comprising the tank of shell liquid 61, a pump (not shown) and a shell liquid delivery pipe 70. As shown, a thread 71 is delivered into the shell liquid delivery system and is dragged by the shell fluid 61 through the nozzle 63 and into the carrier fluid 64 such that it forms a connecting member coupling the droplets to one another. The thread may comprise cotton or acetate yarn. The thread 71 may be drawn into the pipe 70 of the shell liquid delivery unit via a valve (not shown).

As shown, a pair of helical drives 72a, 72b, are disposed in the pipe 65 of carrier fluid 64. In operation, the droplets 66 contact the helical drives, which are rotated by one or more motors (not shown) so as to guide the droplets 66 through the pipe 65 at a predetermined rate. Thus, the separation, or pitch, between the discrete fluid-containing members of the eventual fluid encapsulation may be controlled by adjusting the rate at which the helical drives rotate.

Many further modifications and variations of the apparatus shown in FIG. 15 will be apparent to those skilled in the art.

For example, although the apparatus shown in FIG. 15 shows helical drives for adjusting the pitch of the fluid containing members of the fluid encapsulation, the pitch may alternatively or also be controlled by varying the flow speed of the carrier fluid, thereby adjusting the separation between the droplets carried therewith in the pipe 65. The carrier fluid may, for example, be delivered under pressure from a tank 73 into the pipe 65, thereby carrying the droplets therewith at a rate determined by the applied pressure. Alternatively, or additionally the pitch may be controlled by varying the pressure at which the central and shell liquids are delivered.

In another aspect of the invention, the capsule size may be controlled by applying an ultrasound field to the nozzle 63.

In another aspect of the invention, the thread may be dragged through the tube of carrier fluid by a pulley (not shown).

Still further, although the apparatus of FIG. 15 shows a thread 71, delivered into the shell liquid delivery system such that it forms a connecting member coupling the droplets to one another, the connecting member may alternatively be formed from the gelatin shell fluid rather than from a thread. This may be achieved by, for example, adjusting the rate of rotation of the helical drives 72a, 72b or the pressure at which the shell, core or carrier liquids are delivered such that there is an overlap between the outer shells of neighbouring droplets 66a, 66b formed in the pipe 65. Thus, neighbouring gelatin fluid containing members may be connected by a gelatin connecting member. That is, the fluid-containing members may be integral with the elongate connecting member.

Alternatively, the fluid encapsulation may comprise an elongate gelatin rod having a plurality of fluid containing recesses. The shape of the exterior surface of the encapsulation may be independent of the shape of the exterior surface of the recess.

The above embodiments or alternatives may be used either singly or in combination to achieve the effects provided by the invention.

For example, although the discussion of multi-section filters above relates to the incorporation of a single capsule into a section of a multi-section filter, the skilled person would understand that multi section filters having a section containing multiple capsules therein could also be made using the machines and methods of the present invention.

Many further modifications and variations will be evident to those skilled in the art, that fall within the scope of the following claims:

1. Fluid encapsulation for use in the manufacture of smoking articles, comprising:
first and second spaced, frangible fluid-containing members; and
an elongate connecting member coupling said frangible fluid-containing members to one another.

2. Fluid encapsulation according to claim 1, wherein the first and second frangible fluid-containing members are arranged inside the elongate connecting member.

3. Fluid encapsulation according to claim 1 or claim 2, wherein the connecting member is made from porous plugwrap.

4. Fluid encapsulation according to claim 1, wherein the elongate connecting member is a thread, extending through the frangible fluid-containing members.

5. Fluid encapsulation according to claim 1 wherein the first and second frangible fluid-containing members are integral with the elongate connecting member.

6. Fluid encapsulation according to any of claims 1-5, wherein the first and second frangible fluid-containing members are gelatin capsules.

7. Fluid encapsulation according to claim 5, wherein the shape of the exterior surface of the fluid encapsulation is independent of the shape of the surfaces which encapsulate the fluid.

8. Fluid encapsulation according to any preceding claim, comprising a train of evenly spaced, frangible fluid-containing members, the train including the first and second frangible fluid-containing members.

9. Fluid encapsulation according to claim 8, wherein neighbouring frangible fluid-containing members are coupled together by a connecting member.

10. A method of making a filter rod for use in smoking article manufacture, the method comprising feeding a fluid encapsulation as claimed in any of claims 1-9 such that at least one of said frangible, fluid-containing members is disposed within the rod.

11. A method according to claim 10, wherein the fluid encapsulation is fed into a moving, continuous fibrous mass of filter material; and further comprising steps of
wrapping the continuous fibrous mass having the fluid encapsulation therein with a paper wrapper; and
cutting the wrapped fibrous mass having the fluid encapsulation therein so as to form the filter rod.

12. A method according to any of claim 10 or 11, wherein the fluid encapsulation is fed into the continuous fibrous mass via a centering device.

13. A method according to any of claim 11 or 12, wherein
part of the paper wrapper is in frictional contact with a belt such that movement of the belt imparts movement to the paper wrapper;
part of the continuous fibrous mass is in frictional contact with the paper wrapper such that movement of the paper wrapper imparts movement to the continuous fibrous mass, thereby moving said continuous fibrous mass;
part of the fluid encapsulation is in frictional contact with the continuous fibrous mass such that movement of the continuous fibrous mass imparts movement to the fluid encapsulation, thereby feeding the fluid encapsulation into the continuous fibrous mass.

14. A method of making a filter rod according to any of claims 10 to 13, wherein the frangible fluid-containing members of the fluid encapsulation are spaced such the filter rod comprises a predetermined number of frangible fluid-containing members.

15. A method according to any of claims 11-13, wherein the wrapped fibrous mass is cut such that the filter rod comprises a predetermined number of frangible fluid containing members.

16. A method according to claim 14 or claim 15, wherein the predetermined number is one.

17. A method according to claim 14 or claim 15, wherein the predetermined number is two.

18. A method according to claim 14 or claim 15, wherein the predetermined number is four.

19. A method of making a multi-section filter for a smoking article, comprising:
receiving a first filter section, the first filter section being a filter rod made according to the method of any of claims 10 to 18 or a filter rod as claimed in claim 50;
aligning the first filter section with a second filter section;
wrapping the first filter section and the second filter section with a paper wrapper so as to join them together, thereby forming the multi-section filter.

20. A method of making a multi-section filter for a smoking article, comprising:
receiving a filter rod, the filter rod being a filter rod made according to the method of any of claims 10 to 18 or a filter rod as claimed in claim 50, the filter rod containing two or more frangible fluid-containing members;
cutting the filter rod, thereby forming a first filter section;
aligning the first filter section with a second filter section;
wrapping the first filter section and the second filter section with a paper wrapper so as to join them together, thereby forming the multi-section filter.

21. A method according to claim 19 or claim 20, wherein the second filter section comprises an additive.

22. A method according to claim 21, wherein the additive is charcoal.

23. A method according to claim 19 or claim 20, further comprising steps of:
aligning the second filter section with a mouthpiece section; and
wherein said wrapping further comprises wrapping the mouthpiece section with the paper wrapper so as to join the filter sections with the mouthpiece section, thereby forming the multi-section filter.

24. A method of making a filter rod for a smoking article, further comprising:
making a first filter rod according to the method of claim 18;
forming a plurality of first filter sections by cutting the filter rod such that each first filter section comprises a frangible fluid-containing member;
aligning two of said first filter sections at opposing ends of a second filter section;
aligning a third filter section with said first and second filter sections;
wrapping the first, second and third filter sections together, thereby forming the multi-section filter rod.

25. A method of making a multi-section filter rod according to claim 24, wherein: the second filter section comprises charcoal; and
the third filter rod comprises a mouthpiece section.

26. A method comprising:
forming an elongate connecting member between first and second frangible, fluid-containing members, thereby making a fluid encapsulation for use in the manufacture of smoking articles, the fluid encapsulation comprising the first and second frangible, fluid-containing members and the elongate connecting member.

27. A method according to claim 26, wherein the first and second fluid-containing members are gelatin capsules and the elongate connecting member is formed from porous plugwrap.

28. A method according to claim 27, wherein forming the elongate connecting member comprises:
forming a tube of porous plugwrap;
successively blowing the first and second fluid-containing members into the tube;
fixing the first and second fluid-containing members to the inside of the tube, thereby coupling said capsules to the tube and to one another.

29. A method according to claim 28, wherein the first and second fluid-containing members are fixed to the inside of the tube by ultrasonic welding.

30. A method according to claim 29, wherein the fluid-containing members are fixed to the inside of the tube by spot welding.

31. A method according to claim 26, wherein the frangible fluid-containing members have an outer shell and an inner fluid, and further comprising:
forming the frangible fluid containing members by delivering a shell fluid for forming the outer shell and said inner fluid, into a carrier fluid, wherein the shell fluid solidifies and thereby forms the outer shell.

32. A method according to claim 31, further comprising delivering a thread with the shell fluid such that the thread extends through the first and second fluid containing-members, thereby forming the elongate connecting member connecting the frangible fluid-containing members to one another.

33. A method according to claim 26, wherein the frangible fluid-containing members have an outer shell and an inner fluid, and further comprising:
forming the frangible fluid containing members and the elongate connecting member by delivering a shell fluid for forming the outer shell and said inner fluid into a carrier fluid, in which the shell fluid solidifies and thereby forms the outer shell and the elongate connecting member.

34. An apparatus for making a filter rod for a smoking article, the apparatus comprising a feeding mechanism configured to feed a fluid encapsulation as claimed in any of claims 1-9 such that at least one of said frangible fluid-containing members is disposed within the rod.

35. An apparatus according to claim 34, wherein the feeding mechanism is arranged to feed the fluid encapsulation into a moving, continuous fibrous mass, and further comprising:
a conveying mechanism configured to move the continuous fibrous mass along a path;
a garniture configured to wrap the continuous fibrous mass having the fluid encapsulation therein with a paper wrapper; and
a cutter configured to cut the wrapped fibrous mass having the fluid encapsulation therein so as to form the filter rod.

36. An apparatus according to claim 34 or claim 35, further comprising a centering device for axially centering the fluid encapsulation in the filter.

37. An apparatus according to any of claims 34-36, further comprising a holder, wherein the feeding mechanism comprises an endless belt, the belt forming part of the garniture, and wherein the belt is configured to impart movement to the paper wrapper such that frictional contact between the paper wrapper and the continuous fibrous mass imparts movement to the continuous fibrous mass and such that frictional contact between the continuous fibrous mass and the fluid encapsulation imparts movement to the fluid encapsulation, thereby feeding the fluid encapsulation from the holder.

38. An apparatus comprising:
an assembly station configured to form an elongate connecting member between first and second frangible, fluid containing members, thereby making a fluid encapsulation for use in the manufacture of smoking articles, the fluid encapsulation comprising the first and second, frangible, fluid-containing members and the elongate connecting member.

39. An apparatus according to claim 38, wherein the first and second fluid-containing members are gelatin capsules and the elongate connecting member is formed from porous plugwrap.

40. An apparatus according to claim 39, wherein the assembling station comprises:
a forming block configured to form a porous plugwrap tube from porous plugwrap drawn from a reel;
a capsule delivery mechanism configured to successively deliver capsules into the paper tube.

41. An apparatus according to claim 40, wherein the capsule delivery mechanism comprises first and second capsule delivery mechanisms respectively configured to deliver the first and second fluid containing members into the tube.

42. An apparatus according to claim 40 or 41, further comprising a guiding member, and wherein the capsules are delivered into the paper via the guiding member.

43. An apparatus according to claim 42, further comprising a branched guiding member, the branched guiding member having first and second branches and an output part; and wherein
the first capsule delivery mechanism is configured to deliver the first fluid containing member into the first branch of the branched guiding member, through the output part and into the tube; and
the second capsule delivery mechanism is configured to deliver the second fluid containing member into the second branch of the branched guiding member, through the output part and into the tube.

44. An apparatus according to claim 40-43, wherein:
the capsule delivery mechanism comprises a rotatable hopper and an air-jet blower; and
the rotatable hopper is configured to successively guide capsules from a capsule delivery area to a blowing position; and
the air jet blower is configured to blow capsules from the blowing position into the tube.

45. An apparatus according to claim 44, wherein the axis of rotation of the rotatable hopper is at an angle to the direction of the air jet from the blower such that capsules have a velocity component along the direction of the air jet before they are blown into the tube by the blower.

46. An apparatus according to any of claim 40-45, wherein the assembly station further comprises an ultrasonic welder configured to weld capsules to the inside of the tube.

47. An apparatus according to claim 46, wherein the frangible fluid-containing members have an outer shell and an inner fluid, and wherein the assembly station is further configured to form the frangible fluid containing members by delivering shell fluid for forming the outer shell and said inner fluid into a carrier fluid, wherein the shell fluid solidifies and thereby forms the outer shell.

48. An apparatus according to claim 38, wherein the assembly station is further configured to deliver a thread with the shell fluid such that the thread is arranged inside first and second fluid containing-members, thereby forming the elongate connecting member connecting the frangible fluid-containing members to one another.

49. An apparatus according to claim 47 or 48, wherein the assembly station further comprises first and second helical drives for controlling the separation between the frangible fluid-containing members.

50. A filter rod for use in smoking article manufacture, the filter rod comprising a fluid encapsulation, the fluid encapsulation having:
a frangible fluid-containing member; and
a part of an elongate connecting member coupled to the frangible fluid-containing member.

51. A filter rod according to claim 50, the filter rod having first and second sections, wherein the fluid encapsulation is contained in the first section.

52. A filter rod according to claim 51, wherein the second section comprises an additive.

53. A filter rod according to claim 52, wherein the additive is charcoal.

54. A filter rod according to claim 51, further comprising a second fluid encapsulation, the second fluid encapsulation comprising a frangible fluid-containing member and a part of an elongate connecting member coupled to the frangible fluid-containing member, wherein the second fluid encapsulation is contained in the second filter section.

55. A filter rod according to claim 54, wherein the frangible fluid-containing members of the first and second fluid encapsulations respectively comprise first and second different liquid flavourants.

56. A filter rod according to claim 54 or claim 55, further comprising a third filter section, wherein the third filter section comprises an additive.

57. A filter rod according to claim 56, wherein the additive is charcoal.

58. A filter rod according to any of claims 50 to 57, further comprising a mouthpiece filter section.

59. A method of making a smoking article having a rod of smokeable material, the method comprising:
joining a filter rod, as claimed in any of claims 50-58, to the rod of smokeable material by wrapping the filter rod at least partially with a tipping paper.

60. A method of making a pair of smoking articles, each smoking article having a rod of smokeable material, comprising:
joining a filter rod, as claimed in any of claims 50-58 and containing two or more frangible fluid-containing members, to both rods of smokeable material by wrapping the filter rod at least partially with a tipping paper;
cutting the filter rod in two, thereby forming the pair of smoking articles, each comprising a portion of the filter rod having at least one frangible fluid-containing member.

61. An apparatus for making a smoking article having a rod of smokeable material, the apparatus comprising an assembling station configured to:
receive a filter rod as claimed in any of claims 50-58;
join the filter rod to the rod of smokeable material by wrapping the filter rod at least partially with a tipping paper.

62. An apparatus for making a pair of smoking article, each smoking article having a rod of smokeable material, the apparatus comprising an assembling station configured to:
join the a filter rod, as claimed in any of claims 50-58 and containing two or more frangible fluid-containing members, to both rods of smokeable material by wrapping the filter at least partially with a tipping paper;
cut the filter rod in two, thereby forming the pair of smoking article, each comprising a portion of the filter rod having at least one frangible fluid-containing member.

63. A smoking article comprising a filter rod as claimed in any of claims 50-58.
